(19) United States
(12) Patent Application Publication
(10) Pub. No.: US 2026/0171390 A1
(43) Pub. Date: Jun. 18, 2026

(54) ELECTRODE PLATE MANUFACTURING METHOD AND SYSTEM

(71) Applicant: SAMSUNG SDI CO., LTD., Yongin-si (KR)

(72) Inventors: Yongin KIM, Yongin-si (KR); Yongsoo Kim, Yongin-si (KR)

(21) Appl. No.: 19/259,244

(22) Filed: Jul. 3, 2025

(30) Foreign Application Priority Data
Dec. 12, 2024 (KR) 10-2024-0184971

(51) Int. Cl. H01M 4/04

(52) U.S. Cl. CPC H01M 4/0435

(57) ABSTRACT

A method of manufacturing an electrode plate includes applying an active material to a first region of a surface of a substrate, applying a temporary material to a second region of the surface of the substrate, pressing, through a press process, the substrate to which the active material and the temporary material are applied, and removing the temporary material to form the electrode plate.

### CROSS-REFERENCE TO RELATED APPLICATION

This application claims priority under 35 U.S.C §119 to Korean Patent Application No. 10-2024-0184971, filed in the Korean Intellectual Property Office on December 12, 2024, the entire contents of which are hereby incorporated by reference.

### BACKGROUND

### 1. Field

The subject matter described herein relates to an electrode plate manufacturing method and an electrode manufacturing system.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

In some embodiments, a method of manufacturing an electrode plate may include applying an active material to a first region of a surface of a substrate, applying a temporary material to a second region of the surface of the substrate, rolling, through a press process, the substrate to which the active material and the temporary material are applied, and removing the temporary material to form the electrode plate.

In some embodiments, applying the temporary material may include applying a UV-curable material to the second region.

In some embodiments, the UV-curable material may include an acrylate compound.

In some embodiments, the first region and the second region may be alternately arranged along a width direction perpendicular to an extending direction of the substrate.

In some embodiments, a surface of the active material applied to the first region and a surface of the temporary material applied to the second region may be in direct contact.

In some embodiments, applying the temporary material may include applying the temporary material such that a difference between a height of the active material and a height of the temporary material is equal to or less than a predetermined threshold.

In some embodiments, applying the temporary material may be performed after applying the active material.

In some embodiments, applying the active material may be performed after applying the temporary material.

In some embodiments, applying the active material and applying the temporary material may be performed simultaneously.

In some embodiments, rolling the substrate may include performing the press process by pressing, with a uniform pressure along the extending direction of the substrate, the substrate to which the active material and the temporary material may be applied by a rolling roller.

In some embodiments, removing the temporary material to form the electrode plate may include at least one of scraping and removing the temporary material from the substrate, dissolving the temporary material with a diluent to remove the temporary material, or removing the temporary material by suction.

In some embodiments, the method may further include cutting the electrode plate along an extending direction of the substrate.

In some embodiments, an electrode plate manufacturing system may include a first tank configured to store an active material, a second tank configured to store a temporary material, a first coating device connected to the first tank and configured to apply the active material to a first region of a surface of a substrate, a second coating device connected to the second tank and configured to apply the temporary material to a second region of the surface of the substrate, a rolling roller configured to perform a press process by rolling the substrate to which the active material and the temporary material are applied, and a temporary material removal device configured to remove the temporary material so as to form an electrode plate.

In some embodiments, the temporary material may include a UV-curable material.

In some embodiments, the UV-curable material may include an acrylate compound.

In some embodiments, the first coating device and the second coating device may be configured to alternately apply the active material and the temporary material along a width direction perpendicular to an extending direction of the substrate.

In some embodiments, the first coating device and the second coating device may be configured to apply the active material and the temporary material such that a difference between a height of the active material and a height of the temporary material is equal to or less than a predetermined threshold.

In some embodiments, the rolling roller may be configured to perform the press process by pressing, with a uniform pressure along an extending direction of the substrate, the substrate to which the active material and the temporary material are applied.

In some embodiments, the temporary material removal device may include at least one of a first device configured to scrape and remove the temporary material from the substrate, a second device configured to dissolve the temporary material with a diluent and remove the temporary material, or a third device configured to remove the temporary material by suction.

In some embodiments, the system may further include a slitting device configured to cut the electrode plate along an extending direction of the substrate.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an example of a secondary battery according to an embodiment of the present disclosure.

FIG. 2 is a schematic diagram illustrating an electrode plate manufacturing system according to an embodiment of the present disclosure.

FIG. 3 illustrates an example of an electrode plate and a secondary battery manufacturing equipment included in an electrode plate manufacturing system according to an embodiment of the present disclosure.

FIG. 4 is a cross-sectional view illustrating a modified example of an electrode plate corresponding to line A-A of FIG. 3.

FIG. 5 is a perspective view illustrating an example of the electrode plate of FIG. 4.

FIG. 6 illustrates an example of a slot die coater configuration, which is a coating device according to an embodiment of the present disclosure.

FIG. 7 is a cross-sectional view illustrating an example of an electrode plate cut along line A-A of FIG. 3.

FIG. 8 is a perspective view illustrating an example of the electrode plate of FIG. 7.

FIG. 9 is a flowchart illustrating a method of manufacturing an electrode plate according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being "on," "connected to," or "coupled to" another element or layer, it may be directly on, connected, or coupled to the other element or layer or one or more intervening elements or layers may also be present. When an element or layer is referred to as being "directly on," "directly connected to," or "directly coupled to" another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term "and/or" includes any and all combinations of one or more of the associated listed items. Further, the use of "may" when describing embodiments of the present disclosure relates to "one or more embodiments of the present disclosure." Expressions, such as "at least one of" and "any one of," when preceding a list of elements, modify the entire list of elements and do not modify the individual elements of the list. When phrases such as "at least one of A, B and C, "at least one of A, B or C," "at least one selected from a group of A, B and C," or "at least one selected from among A, B and C" are used to designate a list of elements A, B and C, the phrase may refer to any and all suitable combinations or a subset of A, B and C, such as A, B, C, A and B, A and C, B and C, or A and B and C. As used herein, the terms "use," "using," and "used" may be considered synonymous with the terms "utilize," "utilizing," and "utilized," respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as "beneath," "below," "lower," "above," "upper," and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as "below" or "beneath" other elements or features would then be oriented "above" or "over" the other elements or features. Thus, the term "below" may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms "a" and "an" are intended to include the plural forms as well, unless the context clearly indicates otherwise. It will be further understood that the terms "includes," "including," "comprises," and/or "comprising," when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being "the same" may mean that they are "substantially the same". Thus, the phrase "substantially the same" may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element "above (or below)" or "on (under)" another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly "coupled," "linked" or "connected" to each other, or another component may be "interposed" between the components".

Throughout the specification, when "A and/or B" is stated, it means A, B or A and B, unless otherwise stated. That is, "and/or" includes any or all combinations of a plurality of items enumerated. When "C to D" is stated, it means C or more and D or less, unless otherwise specified.

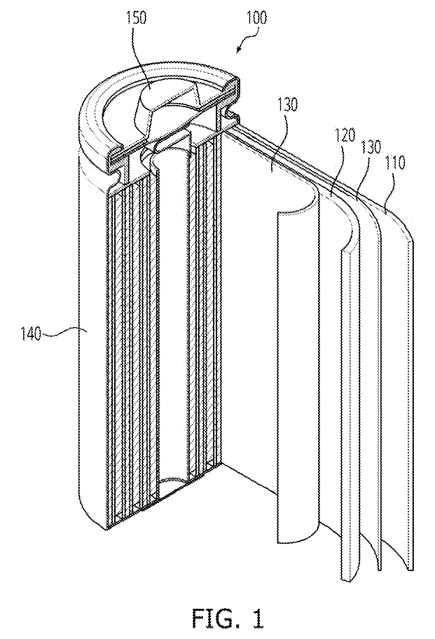

FIG. 1 illustrates an example of a secondary battery 100 according to an embodiment of the present disclosure. According to an embodiment, the secondary battery 100 may include an electrode assembly, a case 140 configured to accommodate the electrode assembly and an electrolyte therein, and a cap assembly 150 coupled to an opening of case 140 and sealing the case 140.

The electrode assembly may include a first electrode 110, a second electrode 120, and a separator 130 interposed between the first electrode 110 and the second electrode 120. The electrode assembly may be accommodated in the case 140 in a rolled or stacked form where the first electrode 110, the separator 130, and the second electrode 120 are arranged in order. Although FIG. 1 shows the case 140 in a cylindrical shape, any suitable shape of a case may be implemented, e.g., the case 140 of the secondary battery 100 may have a cylindrical, prismatic, pouch, or coin shape.

The first electrode 110 may include a first current collector (or substrate) and a first active material layer positioned on the first current collector. A first electrode tab may extend outward from a first uncoated portion of the first current collector, where the first active material layer is not positioned, and the first electrode tab may be electrically connected to the cap assembly 150 or the case 140.

The second electrode 120 may include a second current collector (or substrate) and a second active material layer positioned on the second current collector. A second electrode tab may extend outward from a second uncoated portion of the second current collector, where the second active material layer is not positioned, and the second electrode tab may be electrically connected to the case 140 or the cap assembly 150. For example, the first tab and the second tab may extend in opposite directions.

The first electrode 110 may function as a positive electrode. In this case, the first current collector may be, e.g., an aluminum foil, and the first active material layer may include, e.g., a transition metal oxide. The second electrode 120 may function as a negative electrode. In this case, the second current collector may be, e.g., a copper foil or a nickel foil, and the second active material layer may include, e.g., graphite.

The first electrode tab may include an insulating layer in which an insulating member is disposed. For example, the first electrode tab may include an insulating layer disposed in a region that extends from the first uncoated portion of the first electrode 110. The insulating layer may be disposed on an area of the first electrode 110 that is connected to one surface of the first uncoated portion of the first electrode 110 and that faces the second electrode 120. By providing the insulating layer of the first electrode tab in addition to the separator 130, which is interposed between the first electrode 110 and the second electrode 120, a potential short circuit, when the area of the second electrode 120 is greater than the area of the first electrode 110, may be prevented. For example, by disposing the insulating layer on the first electrode tab, issues of short-circuiting with the second electrode 120 during a process of bending the first electrode tab, which extends from the first uncoated portion of the first electrode 110, may be prevented. This insulating layer may protect the first electrode tab and adjacent components from electrical interference or short circuits that can occur during charge/discharge processes of the secondary battery 100. In an embodiment, the insulating layer included in the first uncoated portion of the first electrode may be formed by removing a portion of a temporary material disposed on the first uncoated portion during the electrode plate manufacturing process.

In an embodiment, a plurality of secondary batteries 100 may be stacked to form a battery pack. Such a battery pack may be used in any device requiring high capacity and high output. For example, it may be used in a laptop computer, a smartphone, or an electric vehicle.

The secondary battery 100 may be a lithium secondary battery, a sodium secondary battery, and so on. Further, the secondary battery 100 may include any battery capable of repeatedly providing electricity through charging and discharging. In an embodiment, if secondary battery 100 is a lithium secondary battery, due to excellent lifespan characteristics and high-rate characteristics, it may be used in an electric vehicle (EV). For example, it may be used in a plug-in hybrid electric vehicle (PHEV) or other hybrid vehicles. Additionally, the lithium secondary battery may be used in fields requiring storage of a large amount of electricity. For example, it may be used in an electric bicycle or an electric power tool.

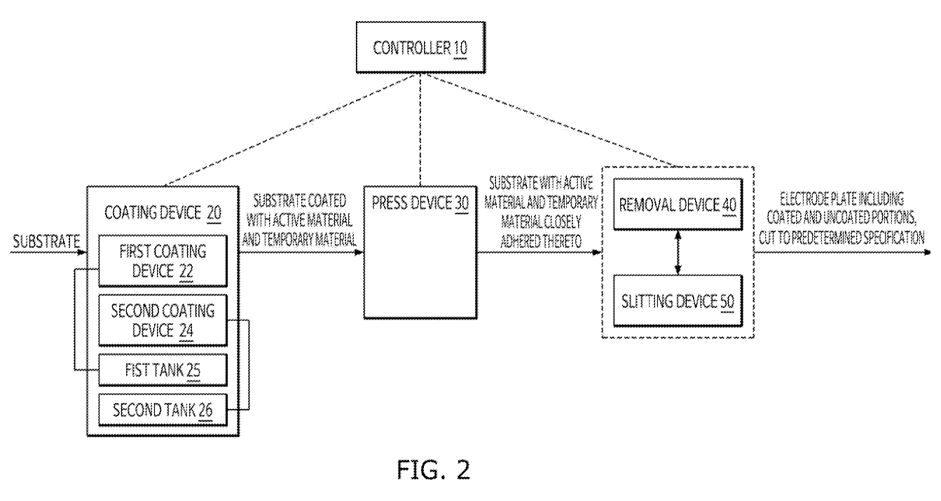

FIG. 2 is a schematic diagram illustrating an electrode plate manufacturing system according to an embodiment of the present disclosure. Referring to FIG. 2, an electrode plate manufacturing system according to some embodiments of the present disclosure may include a controller 10, a coating device 20 (e.g., a coater), a pressing device 30 (e.g., a presser), a removal device 40 (e.g. ,a remover), and a slitting device 50 (e.g., a slitter).

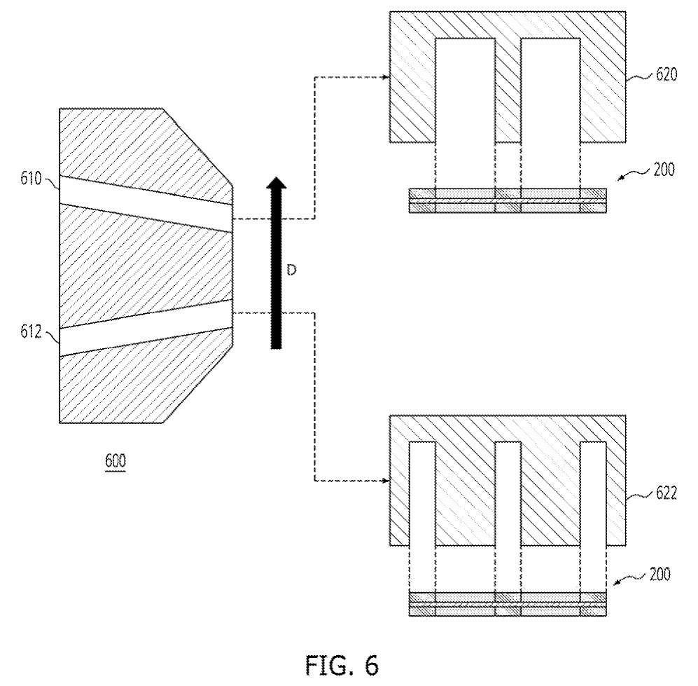

The coating device 20 may apply an active material slurry and a temporary material slurry to a substrate that moves in the transport direction, thereby producing a substrate coated with each of the slurries. The coating device 20 may include a first coating device 22 configured to apply the active material slurry to the first region(s) of one surface of the substrate, and a second coating device 24 configured to apply the temporary material slurry to the second region(s) of the one surface of the substrate. In addition, the coating device 20 may include a third coating device configured to apply the active material slurry to the first region(s) of the other surface of the substrate, and a fourth coating device configured to apply the temporary material slurry to the second region(s) of the other surface of the substrate. Here, the temporary material may include a UV-curable material. Details of coating device 20 of the present disclosure will be described later with reference to FIG. 6.

The first coating device 22 may include a first tank 25 configured to store the active material slurry, a first control valve configured to control the supply of the active material slurry, and a first die coating device configured to discharge the active material slurry onto the substrate. The active material slurry stored in the first tank may be supplied by the first control valve to the first die coating device. The first die coating device may form a first coating layer or a coated portion by applying the active material slurry to the substrate moving in the transport direction.

The second coating device 24 may include a second tank 26 configured to store the temporary material slurry, a second control valve configured to control the supply of the temporary material slurry, and a second die coating device configured to discharge the temporary material slurry onto the substrate. The temporary material slurry stored in the second tank may be supplied by the second control valve to the second die coating device. The second die coating device may form a second coating layer by applying the temporary material slurry to the substrate moving in the transport direction. If the temporary material includes a UV-curable material, the second coating device 24 may include a UV irradiation device configured to cure the UV-curable slurry by irradiating it with ultraviolet (UV) light.

In an embodiment, the electrode plate manufacturing system may include a gas spraying device. The gas spraying device may spray gas onto the first and second coating layers formed by the coating device 20. The gas spraying device may spray gas onto the upper surface and/or side surfaces of the first and second coating layers to form the surfaces of the first and second coating layers uniformly. Here, any suitable gas may be implemented, as long as the gas does not chemically react with each of the first and second coating layers.

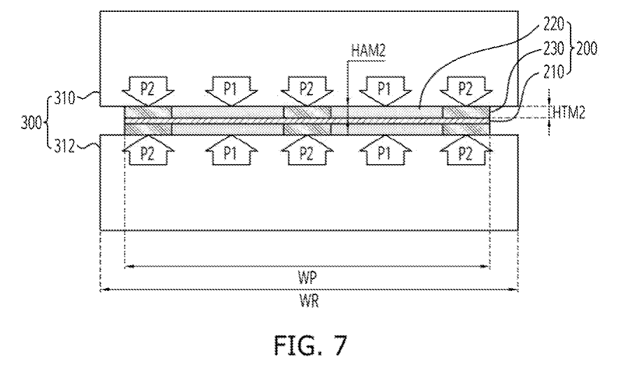

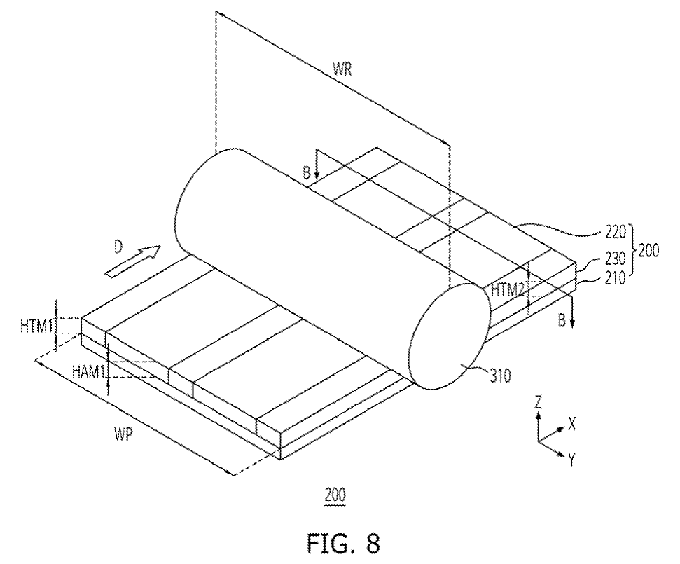

The pressing device 30 may roll (e.g., roll on or along to press) the substrate coated by the coating device 20, thereby generating the substrate on which the active material and the temporary material are tightly bonded in a coated state. The pressing device 30 may include a rolling roller configured to press the coating layer of the substrate, a pressure control device configured to finely adjust pressure, and a gap adjusting device configured to adjust a gap of the rolling roller according to the thicknesses of the coating layer and/or the substrate. Here, the pressing device 30 may include a pair of rolling rollers into which the coated substrate is inserted in the transport direction. However, the arrangement and number of the rolling rollers may vary, and one or more rollers may be arranged according to pressing process specifications and substrate coating specifications (e.g., single-side coating or double-side coating). The pressing device 30 may be configured to perform a pressing process in which the rolling roller rolls the substrate having the active material and the temporary material applied thereto along the transport direction of the substrate (i.e., the movement path direction of the substrate). A detailed description of the pressing process by the pressing device 30 of the present disclosure is provided below with reference to FIGS. 7 and 8.

A temporary material removal device (i.e., the removal device 40) may be configured to remove at least a portion of the temporary material from the substrate having the active material and the temporary material coated thereon to form the electrode plate. The removal device 40 may be configured to remove at least a portion of the temporary material applied to the second region(s), which is a region of the substrate where the active material is not applied. At least a portion of the second region on the substrate may function as a non-coated portion.

In an embodiment, the removal device 40 may include a heating device configured to thermally remove the temporary material, a solvent spraying device (e.g., a dissolver) configured to dissolve and remove the temporary material using a solvent, a scraper configured to physically remove the temporary material, and a suction or intake unit (e.g., a vacuum) configured to remove any residues after removing the temporary material. The scraper may be configured to scrape off the temporary material coated on the substrate. The solvent spraying device may be configured to dissolve the temporary material in a diluent and remove it. However, the detailed configuration of the removal device 40 may vary. For example, the temporary material may be a UV-curable material. When the temporary material is a UV-curable material, the removal device 40 may include a scraper or brush device configured to physically remove the cured UV-curable material, and a suction device configured to remove residues after removal.

In an embodiment, the removal device 40 may include a pattern forming device configured to remove the coated temporary material in a specific pattern such that some portion remains on the substrate. For example, the pattern forming device may irradiate a high-power laser onto the temporary material coating layer to form a precise pattern in the temporary material coating layer and selectively remove only a particular portion. The pattern forming device may include a masking device. The masking device may be configured to protect a portion of the temporary material coated on the substrate by covering it with a mask, and selectively remove the remaining unmasked portions.

The slitting device 50 may be configured to cut the substrate or the electrode plate including the active material coating layer in the transport direction (i.e., an extending direction or a lengthwise direction of the substrate). The slitting device 50 may be configured to cut the substrate to a certain width, thereby separating the coated substrate according to subsequent process specifications. The slitting device 50 may include a blade device configured to cut the substrate in the transport direction, and a guide device configured to cut the substrate to a predetermined width. The slitting device 50 may be arranged on a line separate from the coating device 20, the pressing device 30, and/or the removal device 40. The electrode plate manufacturing system may be configured such that the substrate having a coating layer is wound around a winding roll, and then the substrate having the coating layer is supplied from the winding roll to the slitting device 50 arranged on a separate line. However, the arrangement of the slitting device may vary, and multiple devices included in the electrode plate manufacturing system may be arranged on the same line.

In an embodiment, the pressing device 30, the removal device 40, and the slitting device 50 may be combined in various ways according to an electrode plate formation process. For example, the pressing device 30 may transfer the substrate having the tightly coated/bonded active material and temporary material coating to the removal device 40. The removal device 40 may remove at least a portion of the temporary material coated on the substrate transferred from the pressing device 30. Subsequently, the removal device 40 may transfer the substrate from which at least a portion of the temporary material has been removed to the slitting device 50. The slitting device 50 may cut the substrate transferred from the removal device 40 to a predetermined width along the transport direction, thereby producing an electrode plate including a coated portion and a non-coated portion. In another example, the substrate may pass through the pressing device 30 and then be transferred to the slitting device 50. The slitting device 50 may cut the substrate transferred from the pressing device 30 to a predetermined width along the transport direction. The slitting device 50 may then transfer the cut substrate to the removal device 40. The removal device 40 may remove at least a portion of the temporary material coated on the substrate transferred from the slitting device 50, thereby producing an electrode plate including a coated portion and a non-coated portion.

In an embodiment, the controller 10 may control the coating device 20. For example, the controller 10 may control the amount of slurry discharged from the coating device 20. In addition, the controller 10 may synchronize the moving speed of the substrate with the coating speed so that each coating is performed at a constant speed. The controller 10 may control the coating device 20 so that a difference between the height of the active material coating layer and the height of the temporary material coating layer is equal to or less than a predetermined threshold. For example, the controller 10 may control the coating device 20 so that the height of the active material coating layer and the height of the temporary material coating layer are substantially the same. In addition, the controller 10 may adjust the coating width and position of a slot die of the coating device so that each of the active material and the temporary material is accurately coated onto a specific region of one surface of the substrate.

In an embodiment, the controller 10 may control the pressing device 30. For example, the controller 10 may monitor and control in real time the pressure applied by the pressing device 30 to the substrate. The controller 10 may adjust the pressing device 30 so that a uniform pressure is applied across the entire substrate. In addition, the controller 10 may detect the thickness of the substrate and the height of each coating layer to set a pressure condition suitable for each coating layer. Thus, excessive pressure may not damage the coating layers. In addition, the controller 10 may adjust the position and gap of the rolling roller so as to optimize the gap between the rollers according to the transport speed of the substrate and the thickness of the coating layers.

In an embodiment, the controller 10 may control the removal device 40. For example, the controller 10 may detect the remaining amount of the temporary material on the substrate and adjust the removal strength of the removal device 40. In addition, the controller 10 may control a pattern of the removal device 40 according to the shape and thickness of the temporary material coating so that the temporary material is selectively removed only in a predetermined region. Furthermore, the controller 10 may select a removal method suitable for the temporary material (e.g., ultraviolet irradiation, solvent spraying, or mechanical scraping) so that a removal operation optimized for each material is performed.

In an embodiment, the controller 10 may control the slitting device 50. For example, the controller 10 may adjust the cutting speed of the slitting device 50 according to the transport speed of the substrate so that slitting is performed at the exact position. In addition, the controller 10 may control the width to be cut by the slitting device 50 so that the substrate is uniformly slit to a desired width. The controller 10 may sense the cutting position through a sensor mounted on the slitting device 50 to perform fine adjustment or sense the wear state of a slitting blade to provide a notification of replacement or readjustment of the blade if necessary. Through such control, the precision of the slitting process may be improved, and the quality of the substrate may be maintained.

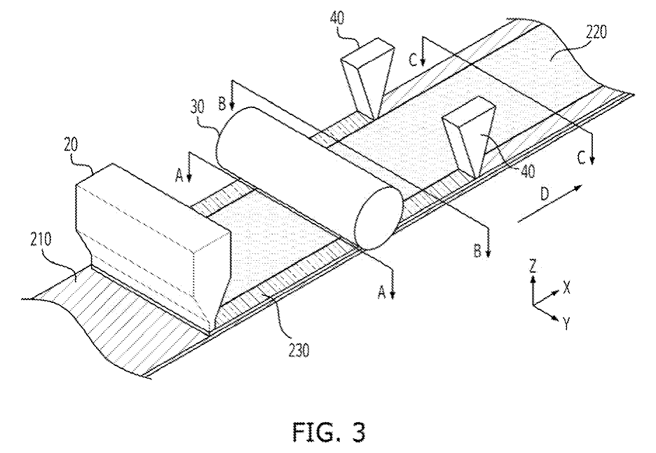

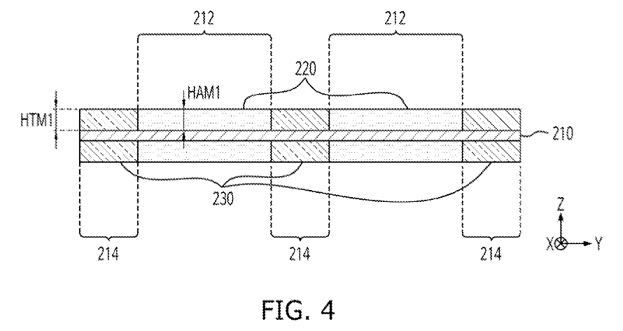

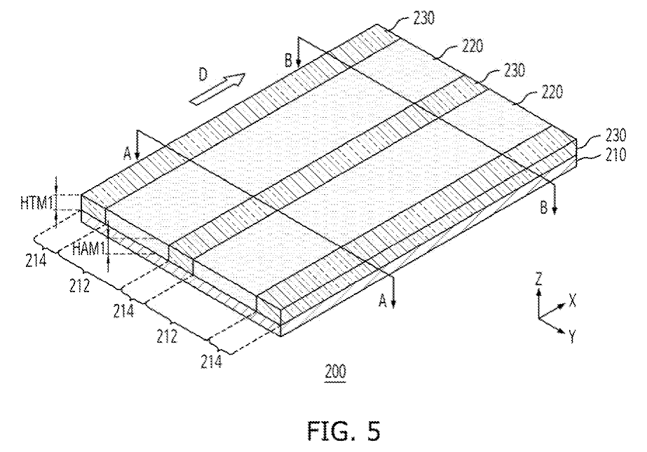

FIG. 3 illustrates an example of an electrode plate and a secondary battery manufacturing equipment included in an electrode plate manufacturing system according to an embodiment of the present disclosure. FIG. 4 is a cross-sectional view illustrating a modified example of an electrode plate corresponding to line A-A of FIG. 3. FIG. 5 is a perspective view illustrating an example of the electrode plate of FIG. 4.

Referring to FIG. 3, the secondary battery manufacturing equipment may include the coating device 20, the pressing device 30, the removal device 40, and a slitting device (FIG. 2). Hereinafter, overlapping descriptions of FIGS. 1 to 2 may be omitted when explaining FIGS. 3 to 5.

Referring to FIG. 3, the coating device 20, the pressing device 30, and the removal device 40 may be spaced apart from each other, and may be sequentially arranged along the movement path of the substrate 210. For example, referring to FIG. 3, each of the coating device 20 and the pressing device 30 may extend lengthwise perpendicularly to the transport direction D of the substrate 210 (e.g., each of the coating device 20 and the pressing device 30 may extend lengthwise along the Y-axis), and may overlap vertically both the first and second regions of the substrate 210 (e.g., have a width that equals at least a combined width of the first and second regions of the substrate 210). For example, referring to FIG. 3, the removal device 40 may be positioned to vertically overlap the second region of the substrate 210 (e.g., only the second region of the substrate 210 among the first and second regions of the substrate 210).

In detail, the coating device 20 may apply each of the active material and the temporary material slurries onto the substrate 210 moving in a transport direction D (e.g., along the first direction X) to form respective coating layers of the active material 220 and the temporary material 230. The coating device 20 may store the active material and the temporary material slurries therein.

In an embodiment, the active material slurry may be an active material slurry in which the active material, a conductive additive, or an additive is mixed in a binder solution. This may be used in manufacturing a positive electrode plate or a negative electrode plate of a secondary battery. The coating device 20 may discharge the stored active material slurry onto a first region(s) 212 of one surface of the substrate 210 (FIG. 4) to form the active material coating layer(s). The coating device 20 may adjust a slot die from which the active material slurry is discharged by using a spacer, thereby controlling the width and thickness of the active material coating layer.

In an embodiment, the temporary material slurry may be applied to the non-coated portion of the substrate to correct a height difference between the coated portion having the active material 220 and the non-coated portion, thereby allowing the pressing device 30 to deliver a uniform pressure across the entire substrate during the pressing process. This may prevent skewing of the electrode plate. After the pressing process, the temporary material 230 may be removed by the removal device 40, and a non-coated portion may be formed in the electrode plate. For example, the temporary material 230 may include a UV-curable material. Here, the UV-curable material may include an acrylate compound.

In an embodiment, the temporary material 230 may be configured to provide stability in the coating and pressing processes. For example, the coating layer of the temporary material 230 first coated on the substrate 210 may serve as a stopper or guide so that the active material 220 is precisely applied to a specific region of one surface of the substrate 210. The temporary material 230 may be configured not to affect physical or chemical properties of the active material 220 or the substrate 210, even when contacting the active material or when pressed by the pressing device 30. The temporary material 230 may stably adhere to the substrate 210 when cured and may receive a uniform pressure together with the active material coating layer by a rolling roller. As an example, when the UV-curable material includes an acrylate compound, the material may rapidly cure upon ultraviolet irradiation and stably adhere to the substrate. Also, the acrylate compound may maintain chemical stability even when contacting the active material during the pressing process.

In an embodiment, the temporary material 230 may include a material that is easily removed in a subsequent process. After the pressing process, the removal device 40 may remove at least a portion of the temporary material 230 from the substrate 210, and a non-coated portion having a predetermined pattern may be formed on the substrate 210 (i.e., in a region from which the temporary material 230 is removed). As an example, the acrylate compound may be selectively and easily removed by irradiation of ultraviolet light of a specific wavelength, treatment with a specific solvent, and/or a mechanical removal method after the pressing process.

Referring to FIG. 3, the active material coating device and the temporary material coating device may be configured as one coating device 20. For example, by using suitable spacers in a single die slot coater, both the active material coating and the temporary material coating may be performed with one device. However, the configuration of the coating device 20 may vary, e.g., the active material coating device and the temporary material coating device may be provided as separate devices. When configured as separate devices, the coating speed for the active material and for the temporary material may each be individually controlled. In one example, the temporary material may be applied after the active material is applied. In another example, the active material may be applied after the temporary material is applied. In yet another example, the temporary material and the active material may be applied simultaneously. A single coating device having multiple spacers is described below in detail with reference to FIG. 6.

The substrate 210 may be provided in a form wound by a roll. The substrate 210 may be moved in the transport direction D by a transport roller or the like. The transport direction D (e.g., the movement path of the substrate 210) may be the same as the first direction X. Here, the first direction X may refer to the X-axis direction in FIG. 3. The substrate 210 may be used to form an electrode plate for manufacturing a positive electrode plate or a negative electrode plate of a secondary battery. The substrate 210 may be a conductive metal foil including copper, a copper alloy, nickel, or a nickel alloy. In another example, the substrate 210 may be a composite substrate in which both surfaces of an insulating material film are coated with a metal.

The coating layers of each of the active material 220 and the temporary material 230 may be formed on a surface (e.g., a single surface or both surfaces) of the substrate 210. Referring to FIG. 3, one active material coating layer and temporary material coating layers adjacent on both sides thereof may be formed on the surface of the substrate 210 along the transport direction D. However, the arrangement of each coating layer on the substrate 210 may vary, e.g., may be configured in various ways according to the specifications of the electrode plate.

In an embodiment, the coating device 20 may apply the active material 220 and the temporary material 230 onto the surface (e.g., a same surface) of the substrate 210 along the first direction X. For example, the active material coating device may apply the active material 220 to the first region(s) 212 of a first surface of the substrate 210 in the center of the substrate 210 along the first direction X, and the temporary material coating device may apply the temporary material 230 to the second region(s) 214 of the first surface of the substrate 210 in the periphery of the substrate 210 (e.g., along lateral sides of the active material coating layer). The first region(s) 212 and the second region(s) 214 may be alternately arranged along a second direction Y (e.g., a width direction) perpendicular to the extending direction or the first direction X of the substrate 210.

In an embodiment, the coating device 20 may apply the active material 220 and the temporary material 230 onto the substrate 210 so that a surface of the active material coating layer applied to the first region 212 directly contacts a surface of the temporary material coating layer applied to the second region 214. In other words, lateral surfaces of the coating layers of the active material 220 and the temporary material 230 that face each other may directly contact each other, so there may be no empty space formed between the active material 220 and the temporary material 230 on the substrate 210. Both the active material 220 and the temporary material 230 on the substrate 210 may have an adhered structure at their boundary portion (e.g., physically and securely attached to each other at the contact region between the active material coating layer and the temporary material coating layer), thereby preventing skewing of the electrode plate by assisting fixation of the active material during the pressing process and allowing a uniform pressure to be transmitted across the entire substrate.

In an embodiment, the coating device 20 may apply the active material 220 and/or the temporary material 230 onto the surface of the substrate 210 so that a uniform pressure may be applied across the entire substrate 210 during the pressing process. For example, each height of the active material 220 and the temporary material 230 may refer to a distance from the surface of the substrate 210 to the surface of each of the active material coating layer and the temporary material coating layer, along a perpendicular direction Z. For example, referring to FIG. 4, the coating device 20 may apply the active material 220 and/or the temporary material 230 onto the surface of the substrate 210 so that a height HAM1 of the active material 220 is substantially the same as a height HTM1 of the temporary material 230. In another example, if a difference between each compressibility of the active material 220 and the temporary material 230 is controlled to be equal to or less than a predetermined threshold, the pressing device 30 may distribute a load uniformly across the entire substrate.

In an embodiment, the pressing device 30 (e.g., a rolling roller) may be configured to roll at a uniform pressure along an extending direction (i.e., the first direction X) of the substrate 210, the substrate 210 having the active material 220 and the temporary material 230 applied thereto, thereby performing the pressing process. A more detailed description of the pressing process by the pressing device 30 is provided below with reference to FIGS. 7 and 8.

In an embodiment, the removal device 40 may be configured to remove the temporary material 230 from the substrate 210 to form the electrode plate. For example, the removal device 40 may include at least one of a first device configured to scrape the temporary material 230 from the substrate 210, a second device configured to dissolve the temporary material 230 in a diluent, and a third device (e.g., a suction device) configured to remove the temporary material 230 by suction. Through this configuration, the electrode plate cut along line C-C of FIG. 3 may include a coated portion, in which the active material 220 is applied to the first region 212, and a non-coated portion in which neither the active material nor the temporary material 230 is applied to the second region 214.

Referring to FIGS. 4 and 5, the active material 220 may be applied to multiple first regions 212 of the substrate 210, and the temporary material 230 may be applied to multiple second regions 214 of the substrate 210. As shown in FIGS. 4 and 5, the first region 212 and the second region 214 may be alternately arranged along the second direction Y perpendicular to the extending direction of the substrate 210 of the electrode plate 200. Accordingly, the active material 220 and the temporary material 230 may be alternately arranged along the second direction Y perpendicular to the extending direction of the substrate 210. In such a case, there may be one more second region 214 than the number of first regions 212 on the substrate 210.

FIG. 6 illustrates a schematic diagram of a slot-die coater 600 configuration, which is a coating device (e.g., the coating device 20) according to an embodiment of the present disclosure.

Referring to FIG. 6, the slot-die coater 600 may include three die blocks (e.g., stacked on the left side of FIG. 6) and two slots 610 and 612 formed between the three die blocks. In addition, the slot-die coater 600 may include spacers 620 and 622 interposed between the die blocks and inserted into the slots 610 and 612, respectively. Through this configuration, passages for flowing the active material and the temporary material may be formed via the slots 610 and 612, and the flow rates and positions of each of the active material and the temporary material may be individually controlled by the spacers 620 and 622, thereby discharging each material onto the substrate of the electrode plate 200 (right side of FIG. 6).

The die blocks included in the slot-die coater 600 may be stacked and aligned in order along the transport direction D of the electrode plate 200 (e.g., stacked sequentially in the X-axis of FIG. 3 to define the coating device 20). Accordingly, the slots 610 and 612 formed between the die blocks may be aligned in order along the transport direction D of the electrode plate 200 (e.g., the slots 610 and 612 may be arranged sequentially in the X-axis of FIG. 3 to face the substrate 210 of FIG. 3 in the Z-axis).

In an embodiment, the first spacer 620 may be inserted into the first slot 610. Accordingly, the active material flowing through the first slot 610 may be discharged via the first spacer 620. In addition, the first spacer 620 may have an open portion formed by cutting in the direction in which the active material is discharged. The open portion may control a flow rate and position of the first active material discharged by the first spacer 620. Accordingly, a width of the first active material discharged through the first spacer 620 may be determined to be the same as a width of the open portion formed in the first spacer 620 (e.g., dark shaded regions of the electrode plate 200 on the top right side of FIG. 6 formed by the open portion of the first spacer 620).

In an embodiment, a second spacer 622 may be inserted into the second slot 612. Accordingly, the temporary material flowing through the second slot 612 may be discharged via the second spacer 622. The second spacer 622 may have a slit portion formed in the direction in which the temporary material is discharged. The slit portion of the second spacer 622 may include multiple slits and multiple teeth repeated alternately. The temporary material discharged via the second spacer 622 may be discharged through the slits. The flow rate and position of the temporary material discharged by the second spacer 622 may be controlled by the slit portion (e.g., light shaded regions of the electrode plate 200 on the bottom right side of FIG. 6 formed by the slit portions of the second spacer 622).

Here, the slit portion formed in the second spacer 622 may be formed corresponding to the structure of the open portion formed in the first spacer 620. Referring to FIGS. 5 and 6, the open and slit portions of each of the first and second spacers 620 and 622 may be formed so that the first region 212 of the electrode plate 200 is coated with the active material 220 and the second region 214 of the electrode plate 200 is coated with the temporary material 230, arranged alternately along the second direction Y perpendicular to the transport direction D (or extending direction) of the electrode plate 200. In addition, the open and slit portions of each of the spacers 620 and 622 may be formed so that a surface of the active material 220 coated on the first region 212 and a surface of the temporary material 230 coated on the second region 214 are in direct contact with each other.

FIG. 7 is a cross-sectional view illustrating an example of the electrode plate 200 cut along line A-A of FIG. 3. FIG. 8 is a perspective view illustrating an example of the electrode plate 200 in FIG. 7. In an embodiment, the pressing device 30 (FIG. 1) may perform a pressing process by pressing the electrode plate 200 including the substrate 210 having the active material 220 and the temporary material 230 applied thereto. Hereinafter, overlapping descriptions of FIGS. 1 to 6 and FIGS. 7 and 8 may be omitted.

Referring to FIGS. 7 and 8, the pressing device may include a rolling roller 300. For example, as illustrated in FIG. 7, the rolling roller 300 may include an upper rolling roller 310 that presses the upper surface of the electrode plate 200 coated on both surfaces, and a lower rolling roller 320 that presses the lower surface of the electrode plate 200. In another example, as illustrated in FIG. 8, a single rolling roller (i.e., only the upper rolling roller 310) may press a coated surface of the electrode plate 200 coated on one (i.e., a single) surface.

In an embodiment, the rolling roller 300 may roll each of the active material 220 and the temporary material 230 so as to be closely adhered on the substrate 210 (e.g., the rolling roller 300 may the active material 220 and the temporary material 230 simultaneously to impart uniform pressure to both the active material 220 and the temporary material 230). In the transport direction D of the electrode plate 200, after the pressing process, a height HAM1 of the active material coating layer may be smaller than a height HAM1 of the active material coating layer before the pressing process. In addition, after the pressing process, a height HTM2 of the temporary material coating layer may be smaller than a height HTM1 of the temporary material coating layer before the pressing process. Through this, after the pressing process, each of the active material coating layer and the temporary material coating layer has a reduced height, so both coating layers may remain in a more tightly adhered state on the substrate 210.

In an embodiment, the rolling roller 300 may perform the pressing process in physical contact with the electrode plate 200 (e.g., through direct physical contact with the active material 220 and the temporary material 230). A width WR of the rolling roller 300 may be equal to or larger than a width WP of the electrode plate 200 (e.g., in the Y-axis of FIG. 8). Through this configuration, the rolling roller 300 may apply a uniform pressure across an entire surface of the electrode plate 200.

In an embodiment, the rolling roller 300 may press the electrode plate 200 along the transport direction D of the substrate 210 to perform the pressing process. Here, the operation of the rolling roller 300 may be controlled so that a difference between a pressure P1 pressing the active material coating layer on the substrate 210 and a pressure P2 pressing the temporary material coating layer on the substrate 210 is within a predetermined critical pressure range. For example, the pressure P1 pressing the active material coating layer on the substrate 210 and the pressure P2 pressing the temporary material coating layer on the substrate 210 may be substantially the same.

Through this configuration, a height difference between a coated portion and a non-coated portion of the electrode plate 200 may be corrected so that a uniform pressure may be applied across an entire surface of the substrate 210 during the pressing process. In addition, damage or detachment of the active material coating layer during the pressing process may be minimized. Through this, skewing of the electrode plate 200 may be prevented, and uniformity of the coating layer may be maintained.

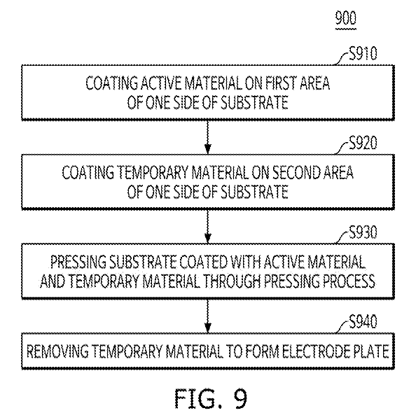

FIG. 9 is a flowchart illustrating a method 900 of manufacturing an electrode plate according to an embodiment of the present disclosure. In an embodiment, the method 900 of manufacturing an electrode plate may be performed by the electrode plate manufacturing system. Hereinafter, overlapping descriptions of FIGS. 1 to 8 and FIG. 9 may be omitted.

Referring to FIG. 9, the method 900 of the present disclosure may include applying an active material to a first region of one surface of a substrate (S910), applying a temporary material to a second region of the one surface of the substrate (S920), rolling (e.g., pressing) the substrate on which the active material and the temporary material are applied through a pressing process (S930), and removing the temporary material to form the electrode plate (S940). Additionally, the method 900 may further include cutting the electrode plate along or perpendicular to the extending direction of the substrate.

In an embodiment, when applying the active material and the temporary material to the substrate, the first region and the second region may be alternately arranged along a width direction perpendicular to the extending direction of the substrate. In addition, a surface of the active material applied to the first region and a surface of the temporary material applied to the second region may be in direct contact with each other. Further, the temporary material may be applied so that a difference between the height of the active material and the height of the temporary material is equal to or less than a predetermined threshold.

In FIG. 9, the method 900 is shown such that applying the active material and the temporary material to the substrate are performed sequentially. However, the sequence of applying each of the active material and the temporary material may vary. For example, applying the temporary material may be performed first, followed by applying the active material. Here, a first coating device applying the active material and a second coating device applying the temporary material may be configured as separate devices. In another example, applying the active material and the temporary material to the substrate may be performed simultaneously. In this case, a single die slot coater and multiple spacers may be implemented.

In an embodiment, when rolling (e.g., pressing) the substrate, a rolling roller may press, at a uniform pressure along the extending direction of the substrate, the substrate on which the active material and the temporary material are applied, thereby performing the pressing process. In an embodiment, removing the temporary material may include at least one of scraping the temporary material from the substrate, dissolving the temporary material in a diluent to remove it, or removing the temporary material by suction.

By way of summation and review, in an electrode plate manufacturing process, skewing of the electrode plate may occur due to a difference in pressure between a coated portion, where an active material is coated, and an uncoated portion, where the active material is not coated. For example, if, during a press process, a region containing the coated portion is subjected to excessive pressure (compared to the uncoated portion), the electrode plate may be distorted to one side because of a difference in strain between the coated portion and the uncoated portion. Such skewing detracts from the uniformity of the electrode plate and may cause coupling of the electrodes, adversely affecting battery performance and lifespan. Therefore, it is desirable to maintain a uniform pressure on the entire surface of the electrode plate during the press process.

Therefore, the present disclosure provides an electrode plate manufacturing method and an electrode plate manufacturing system. That is, by simultaneously coating both the coated and uncoated regions of the electrode, followed by removing the coating from the uncoated region, the height difference between the coated and uncoated regions may be eliminated or substantially minimized, thereby allowing application of uniform pressure during calendering (e.g., pressing process) across the entire surface of the electrode plate and reducing tracking deviation (misalignment).

These and other aspects and features of the present disclosure will be described in or will be apparent from the description of embodiments of the present disclosure.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing an electrode plate, the method comprising:
applying an active material to a first region of a surface of a substrate;
applying a temporary material to a second region of the surface of the substrate;
pressing, through a press process, the substrate to which the active material and the temporary material are applied; and
removing the temporary material to form the electrode plate.

2. The method as claimed in claim 1, wherein applying the temporary material includes applying a UV-curable material to the second region.

3. The method as claimed in claim 2, wherein the UV-curable material includes an acrylate compound.

4. The method as claimed in claim 1, wherein the first region and the second region are alternately arranged along a width direction perpendicular to an extending direction of the substrate.

5. The method as claimed in claim 4, wherein a surface of the active material applied to the first region and a surface of the temporary material applied to the second region are in direct contact.

6. The method as claimed in claim 1, wherein applying the temporary material includes applying the temporary material such that a difference between a height of the active material and a height of the temporary material is equal to or less than a predetermined threshold.

7. The method as claimed in claim 1, wherein applying the temporary material is performed after applying the active material.

8. The method as claimed in claim 1, wherein applying the active material is performed after applying the temporary material.

9. The method as claimed in claim 1, wherein applying the active material and applying the temporary material are performed simultaneously.

10. The method as claimed in claim 1, wherein pressing the substrate includes performing the press process by pressing, with a uniform pressure along an extending direction of the substrate, the substrate to which the active material and the temporary material are applied by a rolling roller.

11. The method as claimed in claim 1, wherein removing the temporary material to form the electrode plate includes at least one of scraping and removing the temporary material from the substrate, dissolving the temporary material with a diluent to remove the temporary material, and removing the temporary material by suction.

12. The method as claimed in claim 1, further comprising cutting the electrode plate along an extending direction of the substrate.

13. An electrode plate manufacturing system, comprising:
a first tank configured to store an active material;
a second tank configured to store a temporary material;
a first coater connected to the first tank and configured to apply the active material to a first region of a surface of a substrate;
a second coater connected to the second tank and configured to apply the temporary material to a second region of the surface of the substrate;
a rolling roller configured to perform a press process by rolling the substrate to which the active material and the temporary material are applied; and
a remover configured to remove the temporary material so as to form an electrode plate.

14. The electrode plate manufacturing system as claimed in claim 13, wherein the temporary material includes a UV-curable material.

15. The electrode plate manufacturing system as claimed in claim 14, wherein the UV-curable material includes an acrylate compound.

16. The electrode plate manufacturing system as claimed in claim 13, wherein the first coater and the second coater are configured to alternately apply the active material and the temporary material along a width direction perpendicular to an extending direction of the substrate.

17. The electrode plate manufacturing system as claimed in claim 13, wherein the first coater and the second coater are configured to apply the active material and the temporary material such that a difference between a height of the active material and a height of the temporary material is equal to or less than a predetermined threshold.

18. The electrode plate manufacturing system as claimed in claim 13, wherein the rolling roller has a width that equals at least a combined width of the first and second regions, the rolling roller being configured to press the substrate with a uniform pressure along an extending direction of the substrate.

19. The electrode plate manufacturing system as claimed in claim 13, wherein the remover includes at least one of a scraper, a dissolver, and a vacuum.

20. The electrode plate manufacturing system as claimed in claim 13, further comprising a slitter configured to cut the electrode plate along an extending direction of the substrate.
